(19) United States
(12) Patent Application Publication
(10) Pub. No.: US 2018/0118982 A1
(43) Pub. Date: May 3, 2018

(54) WARM MELT OPTICALLY CLEAR ADHESIVES AND THEIR USE FOR DISPLAY ASSEMBLY

(71) Applicant: 3M INNOVATIVE PROPERTIES COMPANY, St. Paul, MN (US)

(72) Inventors: Christopher J. Campbell, Burnsville, MN (US); Albert I. Everaerts, Tucson, AZ (US); Ross E. Behling, Woodbury, MN (US); Thomas P. Klun, Lakeland, MN (US); Jason D. Clapper, Lakeland, MN (US); Jonathan J. O'Hare, Oakdale, MN (US); Karl K. Stensvad, Inver Grove Heights, MN (US); Glen A. Jerry, Blaine, MN (US); Daniel H. Carlson, Arden Hills, MN (US)

(21) Appl. No.: 15/570,786

(22) PCT Filed: Apr. 27, 2016
(86) PCT No.: PCT/US2016/029485

§ 371 Date: Oct. 31, 2017

Related U.S. Application Data
(60) Provisional application No. 62/157,203, filed on May 5, 2015.

(51) Int. Cl. C09J 9/00; C09J 133/26; C09J 175/06; C09J 5/00

(52) U.S. Cl. CPC C09J 9/00; C09J 133/26; C09J 175/06; B05D 1/26; C09J 2433/00; C09J 2475/00; C09J 2201/622; C09J 5/00

(57) ABSTRACT

A viscoelastic adhesive composition is provided, wherein at a dispensing temperature of between 35° C. and 120° C., the viscoelastic adhesive composition can be discretely dispensed and has a tan delta of at least 1 as determined by dynamic mechanical analysis at a frequency of 1 Hz and a complex viscosity of less than 5×10³ Pascal-sec at a complex viscosity of less than 5×10³Pascal-sec at a frequency of about 10 radians s⁻¹. Such adhesives have been found useful in forming optical assemblies for producing display panels used in a variety of electronic devices.

### TECHNICAL FIELD

The present disclosure relates generally to viscoelastic adhesive compositions and the piece-part application of the viscoelastic adhesive compositions onto substrates. In particular, the present disclosure relates to the precise coating onto substrates of viscoelastic adhesive compositions and forming laminates from such coated substrates.

### BACKGROUND

Optically clear adhesives (OCAs), and particularly liquid optically clear adhesives (LOCAs), have become prevalent in the display industry to fill the air gap between the optical elements. For example, OCAs can fill the air gap between a cover glass and indium tin oxide (ITO) touch sensors, between ITO touch sensors and a display module, or directly between the cover glass and the liquid crystal module. Recently, several coating processes have been developed for more precisely coating patches of low to moderate viscosity, self-leveling liquids, such as LOCAs, onto substrates.

One known process for applying OCA patches to a substrate makes use of flowable liquid OCAs that behave like low viscosity Newtonian liquids at the application conditions. To prevent flow beyond the desired printing area due to self-leveling of these liquids, the use of a pre-cured dam material (matching the refractive index of the OCA) is often required. This involves an additional process step, and may still potentially lead to overflow of the OCA if a sufficiently precise amount is not dispensed and/or there is no perfect co-planarity between the two substrates that are being bonded with the OCA.

The use of a screen for precise printing LOCA patches has also been described, for example in Kobayashi et al. (U.S. Patent Application Pub. No. 2009/0215351). Additionally, the use of a stencil for precise printing of LOCA patches has been described in PCT International Pub. No. WO 2012/036980. Regardless of whether a screen or a stencil is used, self-leveling of the low to moderate viscosity LOCA may degrade the desired positional accuracy of the LOCA patch placement on the substrate. Nevertheless, such adhesives and processes have been found useful in forming optical assemblies for producing display panels used in a variety of electronic devices.

### SUMMARY

In one embodiment, the present invention is a viscoelastic adhesive composition. At a dispensing temperature of between about 35° C. and about 120° C., the viscoelastic adhesive composition can be discretely dispensed and has a tan delta of at least about 1 as determined by dynamic mechanical analysis at a frequency of 1 Hz and a complex viscosity of less than about 5×10³ Pascal-sec as measured at a frequency of about 10 radians·s⁻¹.

In another embodiment, the present invention is a process including providing a heated coating head, the heated coating head comprising an external opening in flow communication with a source of a viscoelastic adhesive composition; positioning the heated coating head relative to a first substrate to define a gap between the external opening and the first substrate; creating relative motion between the heated coating head and the first substrate in a coating direction; and dispensing a pre-determined quantity of the viscoelastic adhesive composition from the external opening onto at least a portion of at least one major surface of the first substrate to form a discrete patch of the viscoelastic adhesive composition in a predetermined position on at least a portion of the major surface of the first substrate, the patch having a thickness and a perimeter. At a dispensing temperature of between about 35° C. and about 120° C., the viscoelastic adhesive composition has a tan delta of at least about 1 as determined by dynamic mechanical analysis at a frequency of 1 Hz and a complex viscosity of less than about 5×10³ Pascal-sec at a frequency of about 10 radians·s⁻¹.

In yet another embodiment, the present invention is an article including a first substrate, a second substrate, and a viscoelastic adhesive composition positioned between the first substrate and the second substrate. At a dispensing temperature of between about 35° C. and about 120° C., the viscoelastic adhesive composition has a tan delta of at least about 1 as determined by dynamic mechanical analysis at a frequency of 1 Hz and a complex viscosity of less than about 5×10³ Pascal-sec at a frequency of about 10 radians·s⁻¹.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

FIG. 1 is a schematic view of an exemplary coating apparatus.

FIG. 2A is a top view of a portion of a sheet of substrate material having disposed thereon an exemplary patch of viscoelastic adhesive composition.

FIG. 2B is a top view of a section along the length of a web of indefinite length material having disposed thereon a series of patches of viscoelastic adhesive composition.

FIG. 2C is a side view of a portion of a sheet of substrate material having an exemplary patch of viscoelastic adhesive composition having a deliberately non-uniform side profile disposed on it.

FIG. 2D is a top view of the coated sheet of FIG. 2C.

FIG. 2E is a side view of a portion of a sheet of substrate material having disposed thereon an intentionally non-uniform patch of viscoelastic adhesive composition exhibiting an exemplary non-uniform side profile of two elliptically-shaped ribs arranged in a crosswise manner substantially orthogonal to each other.

FIG. 2F is a top view of the coated sheet of FIG. 2E.

FIG. 2G is a top view of a portion of a sheet of substrate material having disposed thereon an intentionally non-uniform patch of viscoelastic adhesive composition exhibiting an exemplary non-uniform side profile of a plurality of substantially parallel elliptically-shaped ribs arranged on a major surface of the substrate

FIG. 2H is a top view of a portion of a sheet of substrate material having disposed thereon an intentionally non-uniform patch of viscoelastic adhesive composition exhibiting an exemplary non-uniform side profile of a plurality of substantially parallel elliptically-shaped ribs arranged on a major surface of the substrate, and a single rib arranged in a crosswise manner substantially orthogonal to the plurality of substantially parallel elliptically-shaped ribs.

FIG. 3 is a plot of the complex viscosities of the acrylate polymers of Examples 1 through 4 as a function of shear rate.

FIG. 4 is a plot of viscosity versus steady-state shear rate from 0.1 to 100 sec⁻¹ at 25° C. for a formulation comprising an acrylate-functionalized polyurethane.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed invention by way of representation of exemplary embodiments and not by express limitations. It should be understood that numerous other modifications and embodiments can be devised by those skilled in the art, which fall within the scope and spirit of this invention.

### DETAILED DESCRIPTION

The present disclosure describes a viscoelastic adhesive composition and methods of piece-part coating a viscoelastic adhesive composition onto a substrate. In particular, methods of coating a viscoelastic adhesive composition onto a rigid substrate (e.g. coverglass, indium tin oxide (ITO) touch sensor stack, polarizer, liquid crystal module, and the like) without the assistance of a printing aid (e.g., a screen, a pre-cured dam), which at least partially overcome some or all of the above-mentioned deficiencies. The methods, which do not generally make use of a stencil, can be used for coating of precisely-positioned patches of (optionally pseudoplastic and/or thixotropic) viscoelastic adhesive compositions onto target substrates without substantial self-leveling or “oozing-out” of the patch on the substrate surface prior to application of a subsequent lamination step. As used in the specification, the term “viscoelastic adhesive composition” means materials that exhibit both viscous and elastic behavior when deformed under an applied shear stress. Typical liquid OCAs are low molecular weight materials which exhibit only viscous character for easy dispensing or coating near or at room temperature. These liquid OCAs may be thixotropic in nature but in essence remain viscous fluids. Once cured, these liquid adhesive turn into predominantly elastic solids.

It has been found that die coating methods can be employed to dispose viscoelastic adhesive compositions accurately and quickly in precision lamination applications involving gap filling between a base substrate (e.g. a display panel) and a cover substrate. Such applications include the lamination of a glass panel onto a display panel in LCD displays, or the lamination of a touch sensitive panel onto a display panel in touch-sensitive electronic devices.

The presently disclosed processes using the viscoelastic adhesive compositions, can, in some embodiments, permit significant improvements in throughput in a coating and lamination process by reducing cycle times and improving yields. Exemplary methods of the present disclosure can permit the precise positioning of a non-self-leveling viscoelastic adhesive patch on a substrate surface with respect to a target position, achieving positional accuracy of the patch placement which has heretofore has not been obtainable in a consistent manner. Some exemplary methods of the present disclosure may be used to precisely coat a viscoelastic adhesive composition onto a rigid substrate without the use of a pattern or a printing aid, such as a stencil, screen, mask or dam.

The viscoelastic compositions of this disclosure are higher molecular weight oligomers or lower molecular weight polymers, which can be piece-part dispensed without adhesive stringing at slightly elevated temperatures of between about 35° C. and about 120 ° C. At these elevated temperatures the adhesive composition can behave more viscous while as a result also becoming less elastic. When cooled in contact with the substrate, the adhesive viscosity and elastic component of the rheology quickly increases helping in the shape retention of the adhesive patch. It is also thought that this rapid change in the viscosity of the adhesive and its visco-elastic balance when contacting the colder substrate can facilitate the clean break away of the visco-elastic adhesive coming from a die from the trialing edge of the adhesive patch.

Unlike most liquid OCAs build from lower molecular weight (meth)acrylates or silicones, the visco-elastic adhesives of this disclosure can retain most or all of the visco-elastic properties in the coated adhesive patch. This adhesive patch may optionally be cured to increased cohesive strength of the adhesive and the durability of an assembly made with such adhesive. However, some of the adhesives of this disclosure may not require a curing step after being piece-part coated on the substrate. Examples of such adhesives are those that are physically crosslinked (for example block copolymers) or ionically crosslinked (for example ionomers or acid/base crosslinked adhesives known in the art). To be suitable for this application these types of materials would still need to meet the criteria outlined in this disclosure.

### Coating Processes

The present disclosure describes a piece part process for dispensing discrete patches of viscoelastic adhesive composition. The process includes providing a heated coating head having an external opening in flow communication with a source of a first viscoelastic adhesive composition, positioning the heated coating head relative to a substrate to define a gap between the external opening and the substrate, creating relative motion between the heated coating head and the substrate in a coating direction, and dispensing a pre-determined quantity of the viscoelastic adhesive composition from the external opening onto at least a portion of at least one major surface of the substrate to form a discrete patch of the viscoelastic adhesive composition in a predetermined position on at least a portion of the major surface of the substrate. The first coating liquid is dispensed at a temperature of between about 35° C. and about 120 ° C. The viscoelastic adhesive composition as dispensed exhibits a tan delta of at least about 1 as determined by dynamic mechanical analysis at a frequency of 1 Hz and a complex viscosity of less than about 5×10³ Pascal-sec at a frequency of about 10 radians·s⁻¹. Each of the patches created by the viscoelastic adhesive composition has a thickness and a perimeter. In one embodiment, a stencil or screen is not used to form the discrete patch.

The process may also include repeating the steps of the immediately preceding paragraph with a second composition. In one embodiment, the second composition may be a viscoelastic adhesive composition or any liquid optically clear adhesive composition, such as a thixotropic or viscous liquid optically clear adhesive. When the second composition is a viscoelastic adhesive composition, the second viscoelastic adhesive composition may be the same or different from the first viscoelastic adhesive composition. In one embodiment, the second adhesive composition overlays at least a portion of the first viscoelastic adhesive composition.

### Viscoelastic Adhesive Compositions

The viscoelastic adhesive composition can be used for piece part coating and is dispensed in discrete patches. As dispensed, the viscoelastic adhesive composition has a complex viscosity of less than about 5×10³ Pascal-sec at a frequency of about 10 radians·s⁻¹, particularly less than about 10³ Pa·sec at a frequency of about 10 radians·s¹, and more particularly between about 500 and about 10³ Pascal-sec at a frequency of about 10 radians·s⁻¹.

In one embodiment, as dispensed, the viscoelastic adhesive composition has a Trouton ratio of between about 3 and about 100, particularly between about 3 and about 50, and more particularly between about 3 and about 25. The Trouton ratio is the ratio of extensional viscosity to shear viscosity. If the extensional viscosity is too high relative to the shear viscosity the dispensing adhesive may remain too elastic in nature at the dispensing temperature and adhesive stringing can result which can cause poor pattern quality or strings of adhesive landing on the substrate where is not permitted for the application. The adhesives of this disclosure may not be cleanly coatable as a patch below about 35° C. because of the high extensional viscosity would dominate the adhesive behavior.

The viscoelastic adhesive composition may also exhibit at least one distinguishing rheological characteristic selected from thixotropic rheological behavior and pseudoplastic rheological behavior. The term “thixotropy” or “thixotropic” with respect to a viscoelastic adhesive composition means that the viscoelastic adhesive composition exhibits a viscosity which decreases with increasing shearing time for the time interval during which the viscoelastic adhesive composition undergoes shear during the process of applying the composition to the substrate. Thixotropic coating adhesives recover or “build” viscosity to at least the static viscosity upon cessation of shearing, e.g. after the viscoelastic adhesive composition is applied to a substrate. The term “pseudoplasticity” or “pseudoplastic” with respect to a viscoelastic adhesive composition means that the viscoelastic adhesive composition exhibits a viscosity which decreases with increasing shear rate.

In some embodiments, the first viscoelastic adhesive composition exhibits a Thixotropic Index, defined as the ratio of the low shear viscosity measured at a shear rate of 0.1 sec⁻¹ to the high shear viscosity measured at 100 sec⁻¹, of at least about 5, particularly at least about 10, and even more particularly at least about 20.

In some embodiments, the first viscoelastic adhesive composition exhibits an Equilibrium Viscosity measured at 25° C. on a coating liquid in a fully relaxed state at a shear rate of 1 sec⁻¹ sufficiently high to prevent self-leveling of the coating liquid on the substrate. In some embodiments, the Equilibrium Viscosity at 25° C. measured at a shear rate of either about 1 sec⁻¹ or about 0.01 sec⁻¹ is at least about 80 Pa·s, particularly at least about 200 Pa·s, more particularly at least about 500 Pa·s, even more particularly at least about 1,000 Pa·s.

Particularly suitable viscoelastic adhesive compositions for use in the foregoing coating processes are optically clear compositions, such as adhesives that are used in making optical assemblies. As used herein, the term “optically clear” refers to a material that has a luminous transmission of greater than about 90 percent, a haze of less than about 2 percent, and opacity of less than about 1 percent in the 400 to 700 nm wavelength range. Both the luminous transmission and the haze can be determined using, for example, ASTM-D 1003-95. In some cases, the color or haze of the adhesive is intentionally controlled, yet the material would still be derived from optically clear material by compounding light scattering particles or dyes for example into the visco-elastic composition. Examples of these scattering particles are polystyrene beads, poly(methylmethacrylate) beads, and silicone beads such as those available from Momentive under the trade name Tospearl. In some embodiments, at least one of the first viscoelastic adhesive composition and the second adhesive composition (or both) is selected to be an OCA composition.

In one embodiment, the viscoelastic adhesive composition has a displacement creep at 25° C. of about 0.2 radians or less when a stress of about 10 Pa is applied to the adhesive for about 2 minutes. Particularly, the viscoelastic adhesive composition has a displacement creep at 25° C. of about 0.1 radians or less when a stress of about 10 Pa is applied to the adhesive for about 2 minutes. In general, displacement creep is a value determined using an AR2000 Rheometer manufactured by TA Instruments having with a measurement geometry of a 40 mm diameter×1° cone at 25° C., and is defined as the rotational angle of the cone when a stress of 10 Pa is applied to the adhesive. The displacement creep is related to the ability of the visco-elastic adhesive layer to resist flow, or sag, under very low stress conditions, such as gravity and surface tension.

The viscoelastic adhesive composition has a delta of at least about 1 in a temperature range of between about 35° C. and about 120 ° C. as determined by dynamic mechanical analysis when a oscillatory torque of 80 microN·m is applied at a frequency of 1 Hz in a cone and plate rheometer.

The viscoelastic adhesive composition also has the ability to regain its non-sag property (i.e. keeping shape of the pattern) within a short amount of time after passing underneath the coating die slot. In one embodiment, the recovery time of the viscoelastic adhesive composition is less than about 60 seconds, particularly less than about 30 seconds, and more particularly less than about 10 seconds.

The viscoelastic adhesive composition can include (meth)acrylates, urethanes, silicones, polyesters, polyolefins or mixtures thereof. The viscoelastic adhesive composition may also include a diluent monomer component. In one embodiment, the curable composition includes no crosslinking agents or diluents. In yet another embodiment, the visco-elastic adhesive composition may be self-crosslinking upon cooling or be radiation or thermally cured.

### Additives

The viscoelastic adhesive composition may include at least one additive selected from heat stabilizers, antioxidants, antistatic agents, thickeners, fillers, pigments, dyes, colorants, thixotropic agents, processing aids, nanoparticles, plasticizers, tackifiers, and fibers. In some embodiments, the additive is present in an amount of about 0.01 to about 10 wt. % relative to the mass of the viscoelastic adhesive composition. Tackifiers may be used at levels up to 100 or even 140 wt. % of the visco-elastic composition relative to 100 wt. % of the polymer in said composition. In some embodiments, the viscoelastic adhesive composition further includes metal oxide nanoparticles having a median particle diameter of about 1 nm to about 100 nm in an amount of about 1 to about 10 wt. %, relative to the total weight of the viscoelastic adhesive composition. Light-scattering particles can also added up to 50% by weight. In one embodiment, the light-scattering particles have a diameter of a few microns up to several hundred microns.

In general, the viscoelastic adhesive composition may include metal oxide particles, for example, to modify the refractive index of the adhesive layer or the viscosity of the viscoelastic adhesive composition (as described below). Metal oxide particles that when dispersed in the visco-elastic adhesive yield a substantially transparent composition may be used. For example, a 1 mm thick disk of the metal oxide particles in an adhesive layer may absorb less than about 15% of the light incident on the disk.

Examples of metal oxide particles include clay, Al₂O₃, ZrO₂, TiO₂, V₂O₅, ZnO, SnO₂, ZnS, SiO₂, and mixtures thereof, as well as other sufficiently transparent non-oxide ceramic materials. The metal oxide particles can be surface treated to improve dispersibility in the adhesive layer and the composition from which the layer is coated. Examples of surface treatment chemistries include silanes, siloxanes, carboxylic acids, phosphonic acids, zirconates, titanates, and the like. Techniques for applying such surface treatment chemistries are known. Organic fillers such as cellulose, castor-oil wax and polyamide-containing fillers may also be used.

Metal oxide particles may be used in an amount needed to produce the desired effect, for example, in an amount of from about 2 to about 10 wt. %, from about 3.5 to about 7 wt. %, from about 10 to about 85 wt. %, or from about 40 to about 85 wt. %, based on the total weight of the adhesive layer. Metal oxide particles may only be added to the extent that they do not add undesirable color, haze or transmission characteristics. Generally, the particles can have an average particle size of from about 1 nm to about 100 nm.

In some embodiments, the viscoelastic adhesive composition can be made thixotropic by adding particles to the composition. In some embodiments, fumed silica is added to impart thixotropic properties, in an amount of from about 2 to about 10 wt %, or from about 3.5 to about 7 wt %.

In some embodiments, the viscoelastic adhesive composition includes a fumed silica. Suitable fumed silicas include, but are not limited to: AEROSIL 200; and AEROSIL R805 (both available from Evonik Industries); CAB-O-SIL TS 610; and CAB-O-SIL T 5720 (both available from Cabot Corp.), and HDK H2ORH (available from Wacker Chemie AG).

In some embodiments, the viscoelastic adhesive composition includes a fumed aluminum oxide, such as AEROXIDE ALU 130 (available from Evonik, Parsippany, N.J.).

In some embodiments, the viscoelastic adhesive composition includes clay such as GARAMITE 1958 (available from Southern Clay Products).

In some embodiments, the viscoelastic adhesive composition includes nonreactive oligomeric rheology modifiers. While not wishing to be bound by theory, non reactive oligomeric rheology modifiers build viscosity at low shear rates through hydrogen bonding or other self-associating mechanisms. Examples of suitable nonreactive oligomeric rheology modifiers include, but are not limited to: polyhydroxycarboxylic acid amides (such as BYK 405, available from Byk-Chemie GmbH, Wesel, Germany), polyhydroxycarboxylic acid esters (such as BYK R-606, available from Byk-Chemie GmbH, Wesel, Germany), modified ureas (such as DISPARLON 6100, DISPARLON 6200 or DISPARLON 6500 from King Industries, Norwalk, Conn. or BYK 410 from Byk-Chemie GmbH, Wesel, Germany), metal sulfonates (such as K-STAY 501 from King Industries, Norwalk, Conn. or IRCOGEL 903 from Lubrizol Advanced Materials, Cleveland, Ohio), acrylated oligoamines (such as GENOMER 5275 from Rahn USA Corp, Aurora, Ill.), polyacrylic acids (such as CARBOPOL 1620 from Lubrizol Advanced Materials, Cleveland, Ohio), modified urethanes (such as K-STAY 740 from King Industries, Norwalk, Conn.), or polyamides.

In some embodiments, non-reactive oligomeric rheology modifiers are chosen to be miscible and compatible with an optically clear viscoelastic adhesive to limit phase separation and minimize haze.

Photoinitiators may be used in the viscoelastic adhesive compositions when curing with UV radiation. Photoinitiators for free radical curing include organic peroxides, azo compounds, quinines, nitro compounds, acyl halides, hydrazones, mercapto compounds, pyrylium compounds, imidazoles, chlorotriazines, benzoin, benzoin alkyl ethers, ketones, phenones, and the like. For example, the adhesive compositions may comprise ethyl-2,4,6-trimethylbenzoylphenylphosphinate available as LUCIRIN TPOL from BASF Corp. or 1-hydroxycyclohexyl phenyl ketone available as IRGACURE 184 from Ciba Specialty Chemicals. The photoinitiator is often used at a concentration of about 0.1 to 10 weight percent or 0.1 to 5 weight percent based on the weight of reactive material in the polymerizable composition.

The viscoelastic adhesive compositions and adhesive layers can optionally include one or more additives such as chain transfer agents, antioxidants, stabilizers, fire retardants, viscosity modifying agents, antifoaming agents, antistatic agents and wetting agents. If color is required for the optical adhesive, colorants such as dyes and pigments, fluorescent dyes and pigments, phosphorescent dyes and pigments can be used.

### Substrates

In one embodiment of the present process, a patch of viscoelastic optically clear adhesive is formed on a rigid sheet or rigid article, e.g. the cover glass for an optical display or a display module. In other embodiments, a discrete patch of viscoelastic optically clear adhesive is formed on a transparent flexible sheet or a transparent flexible web of indefinite length in a roll-to-roll process. Flexible substrates may include flexible glass sheets or webs. A discussion of how flexible glass sheets or webs may be successfully handled in these sorts of embodiments can be found in co-pending and co-assigned U.S. Patent Application No. 61/593,076, titled “COMPOSITE GLASS LAMINATE AND WEB PROCESSING APPARATUS,” (attorney docket number 69517U.S.002) , which is incorporated herein by reference in its entirety.

Thus, in some embodiments, the substrate is a light emitting display component or a light reflecting device component. In some embodiments, the substrate is substantially transparent. In one embodiment, the substrate is comprised of glass. In some embodiments, the substrate is flexible.

In other embodiments, the substrate is a polymeric sheet or web. Suitable polymeric materials include, for example, polyesters such as polyethylene terephthalate (PET), polylactic acid (PLA) and polyethylene naphthalate (PEN); polyimides such as KAPTON (available from DuPont Corp., Wilmington, Del.); polycarbonates such as LEXAN (available from SABIC Innovative Plastics, Pittsfield, Mass.); cyclo olefin polymers such as ZEONEX or ZEONOR (available from Zeon Chemicals LP, Louisville, Ky.); and the like. Absorptive polarizers or circular polarizers, quarter-wave plates, mirror films, diffusers, brightness enhancement films may also be used as substrates for this disclosure.

### Coating Apparatus

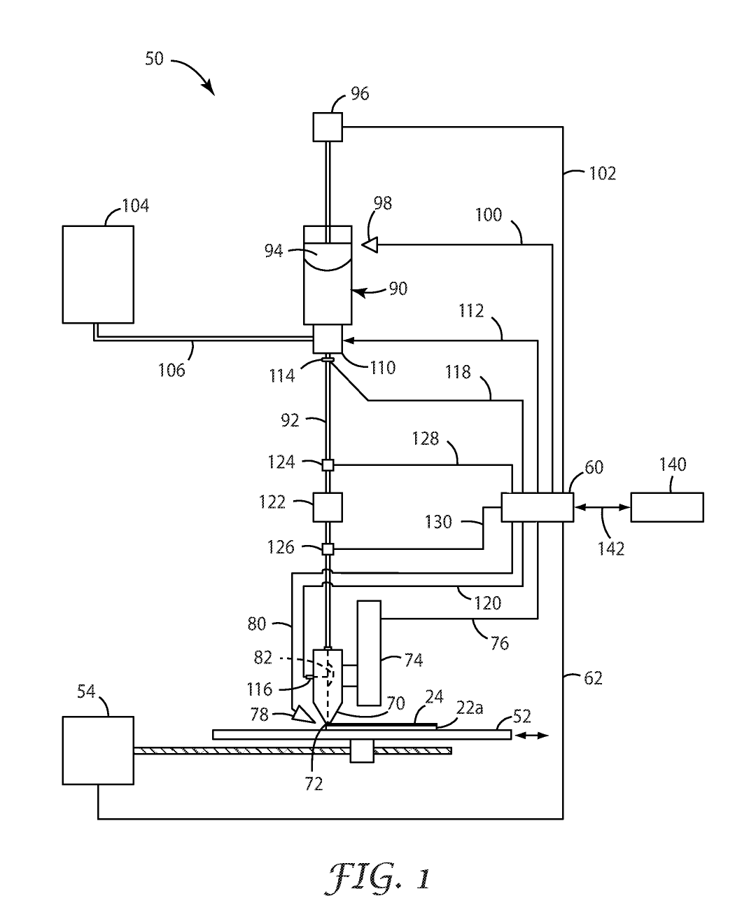

Referring now to FIG. 1, a coating apparatus 50 is illustrated. The apparatus 50 includes a support 52 for the substrate 22a on which the patch 24 is to be dispensed. The support 52 is moved by an actuator 54 (for example, a zero-backlash actuator) during coating of the patch 24. The actuator 54 (among other things) is controlled by controller 60 via signal line 62. In some embodiments, the actuator 54 may have an encoder that reports back to the controller 60; in other embodiments, a separate encoder may be provided for this purpose. While the support 52 in the illustrated embodiment is flat, if the substrate 22a is flexible or arcuate, a cylindrical support moved by a rotational actuator is considered within the scope of the disclosure. Positioned adjacent to the support 52 is a heated coating head 70, which in the illustrated embodiment is a slot die. The heated coating head 70 has an external opening 72, which may be a slot. The heated coating head 70 is moveably mounted so that the distance from its external opening 72 from the surface of the substrate 22a can be controlled by a linear actuator 74, which is in turn controlled by the controller 60 via the signal line 76. Heated coating head 70 is shown in partial cutaway to reveal certain internal structures. At least one position sensor 78 is positioned to sense the distance between the external opening 72 from the surface of the substrate 22a, and reports this information to the controller 60 via a signal line 80.

The heated coating head 70 has a cavity 82 which receives viscoelastic adhesive from a heated syringe pump 90 via a line 92 and delivers fluid to the external opening 72. The plunger 94 of the heated syringe 90 is moved by an actuator 96. A sensor 98 may be positioned to sense the exact position of the plunger 94 and provides feedback via a line 100 to controller the 60 and indirectly to the actuator 96 via a signal line 102. The controller 60 provides a signal to the actuator 96 based on the input of the sensor 98 and according to an equation discussed below which in one embodiment takes into account not only the position function, but also its first, second, and third derivatives. In one embodiment, the bandwidth of the sensor-controller-actuator system is high, e.g. 100 Hz.

In the illustrated embodiment, the viscoelastic adhesive can be drawn from a reservoir 104 via a fluid line 106. A valve 110 is under the control of the controller 60 via a line 112 for the purpose of cycling the system when the heated syringe pump 90 needs to be recharged.

In one embodiment in which the coating adhesive is a viscoelastic adhesive composition, best results are generally achieved if there is low compliance within the heated syringe pump/fluid line/heated coating head system. Air bubbles anywhere within this zone form an undesirable source of compliance. Therefore, in some embodiments, the plunger 94 includes a purge valve through which air bubbles can be purged from the system. In order to detect when inadvertent compliance has entered the system, pressure sensors, positioned at, e.g. 114 and 116, and reporting to the controller 60 via signal lines 118 and 120 respectively may be present. Alternatively, the current drawn by the actuator 96 can be monitored in lieu of the monitoring the pressure. As a further alternative, the system can also verify proper purging by dynamically measuring compliance. A low displacement, high frequency motion from the heated syringe pump while monitoring pressure can detect unwanted compliance in the system.

Improved coating can be achieved as described below when the exact present viscosity of the viscoelastic adhesive is known. Therefore in some embodiments, an orifice 122 is present, and pressure sensors 124 and 126 provide information on the pressure drop across the predetermined static or variable orifice 122 via signal lines 128 and 130 respectively, which information can be processed to take viscosity into account. Adjustability of the orifice 122 is sometimes desirable when the apparatus is asked to handle a wide range a viscosities and flow rates. A display and/or input device 140 in the form of a microcomputer or the like may be present, connected to the controller via data lines, collectively 142.

In one embodiment, the heated coating head is mounted to a fixture that prevents sagging of the heated coating head. The fixture also has precise positioning, particularly with respect to the z-axis, to enable control of the height of the heated coating head relative to the substrate. In one embodiment, the z-axis position can be controlled to within about 0.002 inch (0.00508 cm), particularly to within about 0.0001 inch (0.000254 cm), and more particularly to within about 0.00001 inch (0.0000254 cm).

In one embodiment, the rigid platform, and thus the substrate, moves relative to the heated coating head during the coating process. In another embodiment, the substrate is fixed while the heated coating head moves relative to the rigid platform during the coating process. At the end of the coating process and up through lamination to another substrate, the height and dimensional tolerance of the coated viscoelastic adhesive remain within certain dimensional tolerances.

In additional embodiments, the heated coating head can be selected from the group consisting of: a single slot die, a multiple slot die, a single orifice die, and a multiple orifice die. In certain such embodiments, the heated coating head is a single slot die having a single die slot, further wherein the external opening is comprised of the die slot. In some particular such embodiments, the geometry of the single slot die is selected from a sharp-lipped extrusion slot die, a slot fed knife die with a land, or a notched slot die.

In one embodiment, the heated coating head includes a slot die. Slot die printing and coating methods, which have been used for adhesive coating for web or film to make tape and film products or surface coating, have been found to provide a suitable method for printing viscoelastic adhesive compositions onto a target substrate. Slot dies can be employed to dispose viscoelastic compositions, such as adhesives, accurately and quickly in precision lamination applications involving gap filling between display panel and a cover substrate, such as applications involving the lamination of a glass panel onto a display panel in LCD displays, or the lamination of a touch sensitive panel onto a display panel in touch-sensitive electronic devices.

An example of a slot die for dispensing a feed stream is described in co-assigned co-pending PCT Patent Pub. No. WO 2011/087983, which is incorporated herein by reference in its entirety. Such a slot die can be used to dispense viscoelastic adhesive compositions onto a substrate.

Parameters such as slot height and/or length, conduit diameter, flow channel widths may be selected to provide for a desired layer thickness profile. For example, the cross-sectional area of the flow channels 50 and 52 may be increased or decreased. It may be varied along its length to provide a certain pressure gradient that, in turn, may affect the layer thickness profile of the multilayer flow stream 32. In this manner, the dimensions of one or more of the flow defining sections may be designed to influence the layer thickness distribution of the flow stream generated via the feedblock 16, e.g., based on a target layer thickness profile.

In one embodiment, the heated coating head includes a slot fed knife die containing a converging channel. The geometry of the die could be a sharp lipped extrusion die or a slot fed knife with land on either or both the upstream and downstream lips of the die. A converging channel is preferred to avoid down-web ribbing and other coating defects. (See Coating and Drying Defects: Troubleshooting Operating Problems, E. B. Gutoff, E. D. Cohen, G. I. Kheboian, (John Wiley and Sons, 2006) pgs 131-137). Such coating defects could lead to mura and other noticeable optical defects in the display assembly.

In any of the foregoing embodiments, the source of the first viscoelastic adhesive composition includes a pre-metered viscoelastic adhesive composition delivery system selected from a heated syringe pump, a heated dosing pump, a heated gear pump, a heated servo-driven positive displacement pump, a heated rod-driven positive displacement pump, or a combination thereof.

In some embodiments, the heated coating head is built to handle pressures to shear the viscoelastic adhesive composition into the desired viscosity range. The viscoelastic adhesive composition dispensed through the heated coating head may optionally be pre-heated or heated in the heated coating head to lower the viscosity of the viscoelastic adhesive composition and aid the coating process. In some embodiments, a vacuum box is positioned adjacent to the leading lip of the die to ensure that air is not entrapped between the viscoelastic adhesive composition and the substrate and to stabilize the coating bead.

In some embodiments, the heated coating head is a knife-coater, in which a sharp edge is used to meter the adhesive onto the substrate. The adhesive thickness is generally determined by the gap between the knife and the substrate. The gap is controlled in one embodiment to within about 0.002 inch (0.00508 cm), particularly to within about 0.0001 inch (0.000254 cm), and more particularly to within about 0.00001 inch (0.0000254 cm). An example of a knife-coater heated coating head includes, but is not limited to, a β COATER SNC-280 commercially available from Yasui-Seiki Co., Bloomington, Ind.

An appropriate feed for the first viscoelastic adhesive composition is required. The feed may include, but is not limited to: a heated syringe, heated needle die, heated hopper or a heated liquid dispensing manifold. The feed is engaged to dispense enough of the first viscoelastic adhesive composition for a particular thickness over the coating area on the substrate (potentially through the use of a precision heated syringe pump).

In some embodiments, at least one pressure sensor communicating with the source of the first viscoelastic adhesive composition is used to measure a delivery pressure of the first viscoelastic adhesive composition. The delivery pressure is used to control at least one of the delivery rate of the first viscoelastic adhesive composition to the substrate, or a quality characteristic of the patch.

Suitable quality characteristics include the thickness uniformity of the patch, the positional accuracy and/or precision of the patch position on the substrate relative to a target position (as described further in the next section), the uniformity of the patch perimeter (e.g. the “squareness” of a patch having a square-shaped perimeter), the straightness of an edge of the patch, the absence of coating defects (e.g. bubbles, voids, entrained foreign matter, surface irregularities, and the like), the quantity (e.g. by weight or volume) of the first coating liquid forming the patch, and the like.

### Coated Articles and Laminates

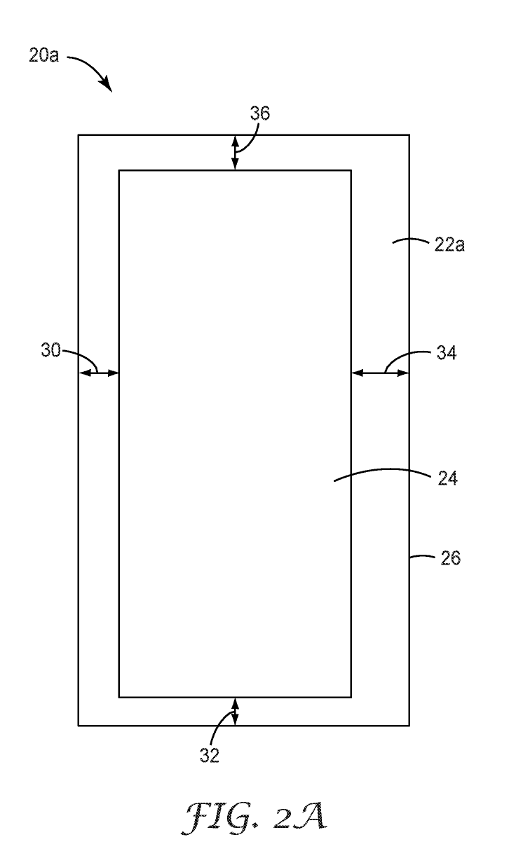

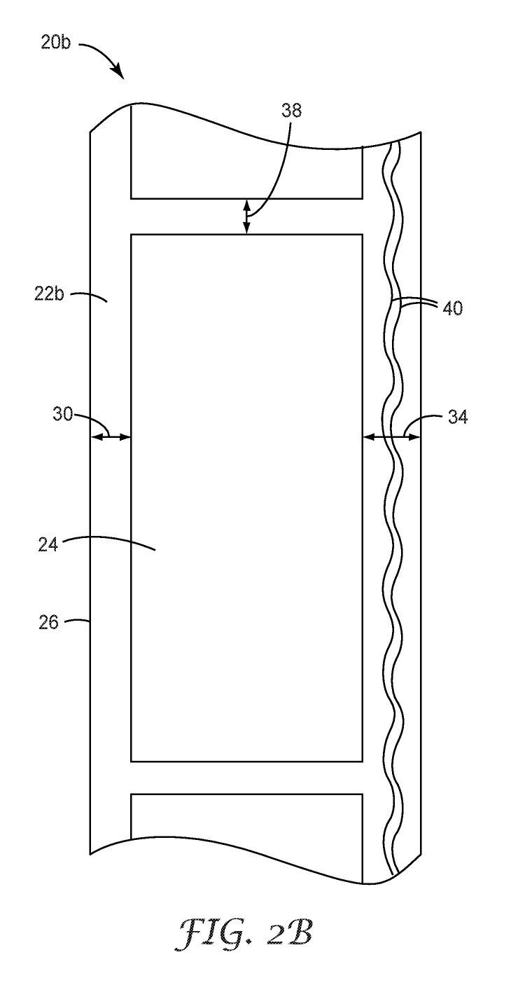

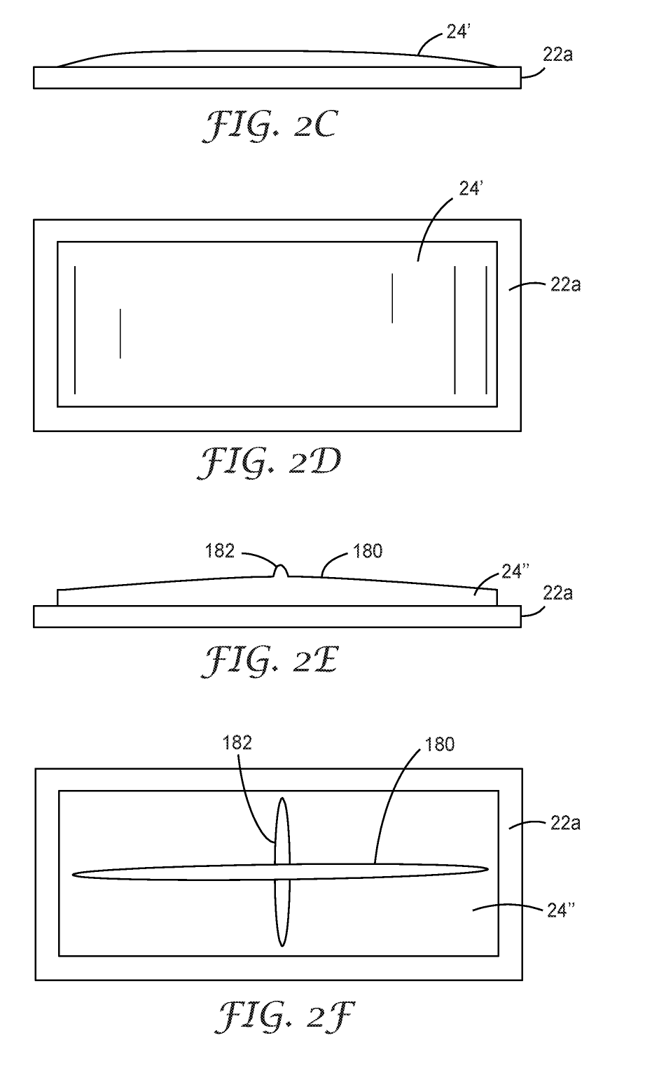

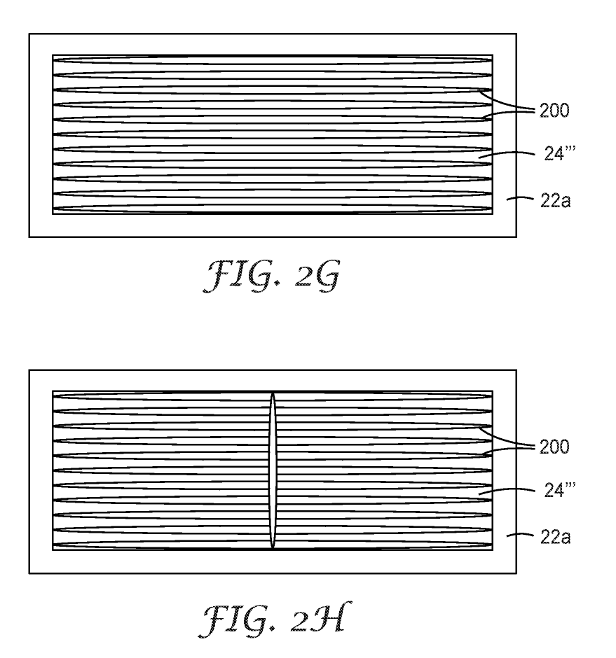

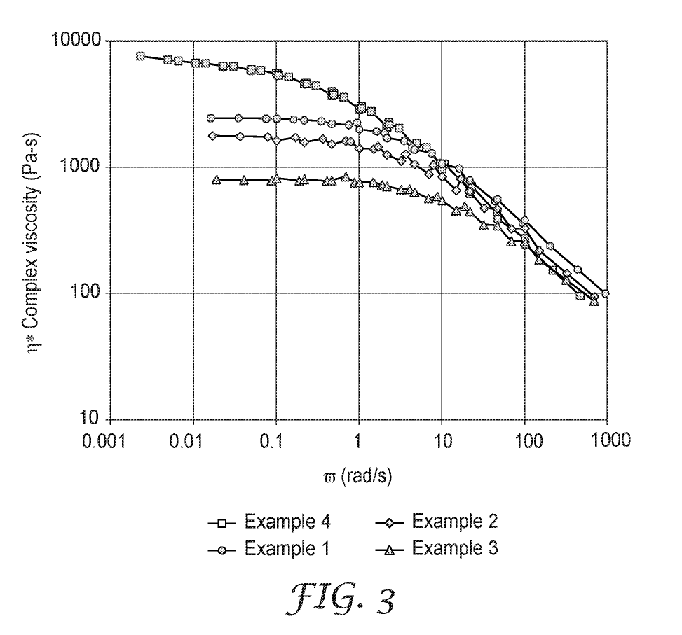

Referring now to FIG. 2A, a top view of a coated sheet 20a, including a piece of sheet material 22a and a patch 24 of viscoelastic adhesive composition disposed upon one of its major surfaces, is illustrated. In the illustrated embodiment, the patch 24 is not coated all the way to the margins 26 of the piece of sheet material 22a, leaving uncoated margins 30, 32, 34, and 36 on all sides of the perimeter of the patch 24. In many applications where the coated patch 24 is to be used in, e.g. a liquid crystal display for a hand-held device, it is convenient to have such margins. Further, it is often convenient for one or more of these margins 30, 32, 34, and 36 to have a pre-determined width, accurate to a close tolerance.

In such applications, positional accuracy within 0.3 mm, or even 0.1 mm can be achieved with the present disclosure. In further embodiments of any of the foregoing, the perimeter of the patch is defined by a plurality of lateral edges of the patch. In such applications, positional accuracy of the patch within about +/−0.3 mm, or even about +/−0.1 mm can be achieved with the present disclosure. In some such embodiments, at least one lateral edge of the patch is positioned relative to an edge of the substrate to within about +/−1,000 μm, about +/−750 μm, about +/−500 μm, or even within about +/−200 μm or about +/−100 μm of a target position.

However, the placement of patches when the size of the margin is not critical, or even when the patches are coated all the way to one or more of the margin edges 26, are considered to be within the scope of the disclosure. In the illustrated embodiment, the patch has a substantially uniform thickness, but this is not considered a requirement of the disclosure, as will be discussed with more particularity in connection with FIGS. 2C and 2D below.

In some embodiments, the viscoelastic adhesive composition is dispensed so as to generate a patch having a thickness of between about 1 μm and about 5 mm, particularly of between about 50 μm and about 1 mm, and more particularly between about 50 μm and about 0.3 mm. In some embodiments, the thickness over the entire coating region is within less than about 10 μm of a predetermined target coating thickness, particularly within less than about 5 μm of the target coating thickness, and more particularly within about 3 μm of the target coating thickness.

In some embodiments, the substrate and the heated coating head move at a speed of between about 0.1 mm/s and about 3000 mm/s relative to one another, particularly between about 1 mm/s and about 1000 mm/s relative to one another, and more particularly between about 3 mm/s and about 500 mm/s relative to one another.

Referring now to FIG. 2B, a top view of a section along the length of a coated web 20b of indefinite length material, including the web 22b and a series of patches 24 of viscoelastic adhesive composition disposed along it, is illustrated. In the illustrated embodiment, the patch 24 is not coated all the way to the margins 26 of the piece of web 22b, leaving uncoated margins 30, and 34 on the sides of the patch 24, and an uncoated space 38 between one patch 24 and the next. In many applications where the coated patch 24 is to be used in, e.g. a liquid crystal display for a hand-held device, it is convenient to have such margins. Further, it is often convenient for one or more of these margins 30 and 34, and uncoated space 38 to have a pre-determined width, accurate to a close tolerance. In such applications, positional accuracy and placement of patches is similar to the coated sheet 20a in FIG. 2A.

Further, the illustrated embodiment includes fiducial marks 40 which can be used to determine the position of the web 22b with great accuracy in both the machine direction and the cross-direction. A more complete discussion of the creation and interpretation of diverse fiducial marks can be found in U.S. Patent Application Nos. 2010/0187277, “SYSTEMS AND PROCESSES FOR INDICATING THE POSITION OF A WEB;” 2010/530544, “TOTAL INTERNAL REFLECTION DISPLACEMENT SCALE;” 2010/530543, “SYSTEMS AND PROCESSES FOR FABRICATING DISPLACEMENT SCALES;” 2012/513896, “APPARATUS AND PROCESS FOR MAKING FIDUCIALS ON A SUBSTRATE;” and 2012/514199, “PHASE-LOCKED WEB POSITION SIGNAL USING WEB FIDUCIALS.”

Referring now to FIG. 2C, a side view of a portion of a sheet of substrate material 22a having a patch of coated viscoelastic adhesive 24′ disposed on one of its major surfaces, is illustrated. In this figure, patch 24′ has a thickness with a deliberately non-uniform side profile. The apparatus of FIG. 1 can produce such a patch by first gradually ramping up the pumping rate and gradually withdrawing the first heated coating head 70 as the substrate is translated to create the gentle curved slope up to the peak, then gradually decreasing the pumping rate and advancing the heated coating head 70 as the substrate is translated. The ordinary artisan will perceive that with a sufficiently detailed programming the controller 60 can produce many profiles for various end uses as long as they are within the bandwidth of the apparatus 50 and the viscosity limitations of the viscoelastic adhesive composition (the composition has a finite Equilibrium Viscosity and cannot be expected to adopt the shape of extremely small features). FIG. 2D is a top view of the coated sheet of FIG. 2C. While patches that are as nearly rectilinear as possible are desirable for some purposes, the techniques of the present disclosure may be used to create profiled patches that are useful for other purposes. In particular, profiled patch 24′ may make the lamination of a rigid cover layer easier.

Referring now to FIG. 2E, a side view of a portion of a sheet of substrate material 22a having a patch of viscoelastic adhesive composition 24″ disposed on one of its major surfaces, is illustrated. In patch 24″ the viscoelastic adhesive composition has a thickness with a deliberately non-uniform side profile. FIG. 2F is a top view of the coated sheet of FIG. 2E. In this view a longitudinal stripe 180 has been created by having an exceptionally wide spot in the slot of the slot die, while crosswise stripe 182 has been created by moving the slot away from the substrate 22a briefly at the proper moment as the substrate 22a is in motion. During this brief moving away, the pumping rate needs to be increased appropriately to deliver the needed extra volume of viscoelastic adhesive composition.

Referring now to FIG. 2G, a side view of a portion of a sheet of substrate material 22a having a patch of viscoelastic adhesive composition 24″′ disposed on one of its major surfaces, is illustrated. In patch 24″′, viscoelastic adhesive composition has a thickness with a deliberately non-uniform side profile. In this view a series of longitudinal ribs 200 has been created by having a series of exceptionally wide spots in the slot of the slot die. This may be referred to as a notched slot or a notched die. An alternative way of achieving a similar surface conformation would be to contact a patch created by a straight slot die with a contacting tool post-coating. For instance, a wire wound rod can be manually pulled over the coating to create a ribbed structure.

Referring now to FIG. 2H, a top view of a coated sheet similar to that of FIG. 2G, except that in addition to longitudinal ribs 200, a crosswise stripe 202 has been created by moving the slot away from the substrate 22a briefly at the proper moment as the substrate 22a is in motion. Similarly to the discussion above in connection with FIG. 2F, during this brief moving away, the pumping rate needs to be increased appropriately to deliver the needed extra volume of viscoelastic adhesive composition.

In any of the foregoing embodiments, the patch may cover only a portion of a first major surface of the substrate. In some embodiments, the perimeter exhibits a geometric shape selected from a square, a rectangle, or a parallelogram. In certain embodiments, the predetermined position is selected such that the perimeter of the patch has a center proximate a center of the major surface of the substrate.

In further embodiments, the thickness of the patch is non-uniform. In some such embodiments, the thickness of the patch is greater proximate the center of the patch, and the thickness of the patch is lower proximate the perimeter of the patch. In certain embodiments, the patch includes at least one raised discrete protrusion extending outwardly from the major surface of the substrate. In some embodiments, the at least one raised discrete protrusion is comprised of at least one raised rib extending across at least a portion of the major surface of the substrate. In some embodiments, the at least one raised rib includes at least two raised ribs arranged cross-wise on the major surface of the substrate. In some embodiments, the at least two ribs intersect and overlap proximate the center of the perimeter of the patch.

In other embodiments, the at least one raised discrete protrusion is a multiplicity of raised discrete protrusions. In some embodiments, the multiplicity of raised discrete protrusions is selected from a plurality of raised discrete bumps, a multiplicity of raised discrete ribs, or a combination thereof. In some embodiments, the multiplicity of raised discrete bumps is comprised of hemispherically-shaped bumps. Optionally, the multiplicity of raised discrete bumps is arranged in an array pattern. In some embodiments, the multiplicity of raised discrete ribs form a dogbone-shaped pattern. In other embodiments, the multiplicity of raised discrete ribs is comprised of elliptically-shaped ribs. In some embodiments, the multiplicity of raised discrete ribs is arranged such that each rib is arranged substantially parallel to each adjoining rib. In some embodiments, at least two of the multiplicity of raised discrete ribs are arranged substantially parallel to each other, and at least one of the multiplicity of raised discrete ribs is arranged substantially orthogonal to the at least two substantially parallel raised discrete ribs.

In alternative embodiments to those described in the preceding two paragraphs, the thickness of the patch is substantially uniform. In one embodiment, a mean thickness of the patch is from about 1 μm to about 500 μm. In some embodiments, the thickness of the patch has a uniformity of about +/−10% of the mean thickness or better.

In further embodiments, the perimeter of the patch is defined by a plurality of lateral edges of the patch. In some embodiments, at least one lateral edge of the patch is positioned relative to an edge of the substrate to within about +/−500 μm of a target position.

### Lamination Processes

The process may also include a lamination step including disposing a second substrate relative to the first substrate such that the patch is positioned between the first and second substrates, wherein the patch contacts at least a portion of each of the first and second substrates, thereby forming a laminate. In one embodiment, the lamination process may be assisted by vacuum or air bleed features incorporated in the patch, such as a rib structure. The lamination process may be advantageously used to make optical assemblies such as display panels.

Optical materials may be used to fill gaps between optical components or substrates of optical assemblies. In one embodiment, optical assemblies comprising a display panel bonded to an optical substrate may benefit if the gap between the two is filled with an optical material that matches or nearly matches the refractive indices of the panel and the substrate. For example, sunlight and ambient light reflection inherent between a display panel and an outer cover sheet may be reduced. In another embodiment, the optical material may have a refractive index different from the refractive index of at least one of the panel and the substrate. Color gamut and contrast of the display panel can be improved under ambient conditions. Optical assemblies having a filled gap can also exhibit improved shock-resistance compared to the same assemblies having an air gap.

### Optical Assemblies

An optical assembly having a large size or area can be difficult to manufacture, especially if efficiency and stringent optical quality are desired. A gap between optical components may be filled by pouring or injecting a curable composition into the gap followed by curing the composition to bond the components together. However, these commonly used compositions have long flow-out times which contribute to inefficient manufacturing methods for large optical assemblies.

The optical assembly disclosed herein comprises an adhesive layer and optical components, particularly a display panel and a substantially light transmissive substrate. Some of the adhesive layers allow one to rework the assembly with little or no damage to the components, while other adhesive layers may yield a more permanent bond. A reworkable adhesive layer may have a cleavage strength between glass substrates of about 15 N/mm or less, 10 N/mm or less, or 6 N/mm or less, such that reworkability can be obtained with little or no damage to the components. Total energy to cleavage can be less than about 25 kg-mm over a 1 by 1 inch (2.54 by 2.54 cm) area.

### Substantially Transparent Substrates

The substantially transparent substrate used in the optical assembly may comprise a variety of types and materials. The substantially transparent substrate is suitable for optical applications and typically has at least 85% transmission of visible light over the range of from 400 to 720 nm. The substantially transparent substrate may have, per millimeter thickness, a transmission of greater than about 85% at 400 nm, greater than about 90% at 530 nm, and greater than about 90% at 670 nm.

The substantially transparent substrate may comprise glass or polymer. Useful glasses include borosilicate, soda lime, and other glasses suitable for use in display applications as protective covers. One particular glass that may be used comprises EAGLE XG and JADE glass substrates available from Corning Inc. Useful polymers include polyester films such as polyethylene terephalate, polycarbonate films or plates, acrylic films such as polymethylmethacrylate films, and cycloolefin polymer films such as ZEONOX and ZEONOR available from Zeon Chemicals L.P. The substantially transparent substrate optionally has an index of refraction from about 1.4 and about 1.7. The substantially transparent substrate typically has a thickness of from about 0.5 to about 5 mm. Other films used in a display stack include absorptive or circular polarizers, quarter wave plates, barrier films such as those used in OLEDs, brightness enhancement films, etc.

The substantially transparent substrate may comprise a touch screen. Touch screens are well known and generally comprise a transparent conductive layer disposed between two substantially transparent substrates.

In some embodiments, the substantially transparent substrates may include an ink step. Using the viscoelastic composition and process of the present invention may enable uniform coverage and leveling of the ink step.

### Adhesive Layers

The viscoelastic adhesive composition forms a layer that may be suitable for optical applications. For example, the viscoelastic adhesive layer may have at least 85% transmission over the range of from 400 to 720 nm. The adhesive layer may have, per millimeter thickness, a transmission of greater than about 85% at 400 nm, greater than about 90% at 530 nm, and greater than about 90% at 670 nm. These transmission characteristics provide for uniform transmission of light across the visible region of the electromagnetic spectrum which is important to maintain the color point in full color displays.

The haze portion of the transparency characteristics of the adhesive layer is further defined by the % haze value of the adhesive layer as measured by haze meters such as a HazeGard Plus available from Byk Gardner or an UltraScan Pro available from Hunter Labs. The optically clear article preferably has haze of the of less than about 5%, preferably less than about 2%, most preferably less than about 1%. These haze characteristics provide for low light scattering which is important to maintain the quality of the output in full color displays.

The refractive index of the adhesive can be controlled by the proper choice of adhesive components. For example, the refractive index can be increased by incorporating oligomers, diluting monomers and the like which contain a higher content of aromatic structure or incorporate sulfur or halogens such as bromine. Conversely the refractive index can be adjusted to lower values by incorporating polymers, oligomers, diluting monomers and the like that contain a higher content of aliphatic structure. For example, the adhesive layer may have a refractive index of from about 1.4 to about 1.7.

The viscoelastic adhesive layer may remain transparent by the proper choice of adhesive components including polymers, oligomers, diluting monomers, fillers, plasticizers, tackifying resins, photoinitiators and any other component which contributes to the overall properties of the adhesive. In particular, the viscoelastic adhesive components should be compatible with each other, for example they should not phase separate before or after cure to the point where domain size and refractive index differences cause light scattering and haze to develop, unless haze is a desired outcome, such as for diffuse adhesive applications. In addition the viscoelastic adhesive components should be free of particles that do not dissolve in the adhesive formulation and are large enough to scatter light, and thereby contribute to haze. If haze is desired, such as in diffuse adhesive applications, this may be acceptable. In addition, various fillers such as thixotropic materials should be so well dispersed that they do not contribute to phase separation or light scattering which can contribute to a loss of light transmission and an increase in haze. Again, if haze is desired, such as in diffuse adhesive applications, this may be acceptable. These viscoelastic adhesive components also should not degrade the color characteristics of transparency by, for example, imparting color or increasing the b* or yellowness index of the adhesive layer.

The adhesive layer can be used in an optical assembly including a display panel, a substantially transparent substrate, and the adhesive layer disposed between the display panel and the substantially transparent substrate.

The viscoelastic adhesive layer may have any thickness. The particular thickness employed in the optical assembly may be determined by any number of factors, for example, the design of the optical device in which the optical assembly is used may require a certain gap between the display panel and the substantially transparent substrate. The viscoelastic adhesive layer typically has a thickness of from about 1 μm to about 5 mm, from about 50 μm to about 1 mm, or from about 50 μm to about 0.3 mm.

### Curing

The process may further includes curing the viscoelastic adhesive composition by applying heat, actinic radiation, ionizing radiation, or a combination thereof.

Any form of electromagnetic radiation may be used, for example, the viscoelastic adhesive compositions may be cured using UV-radiation and/or heat. Electron beam radiation may also be used. The viscoelastic adhesive compositions described above are said to be cured using actinic radiation, i.e., radiation that leads to the production of photochemical activity. For example, actinic radiation may comprise radiation of from about 250 to about 700 nm. Sources of actinic radiation include tungsten halogen lamps, xenon and mercury arc lamps, incandescent lamps, germicidal lamps, fluorescent lamps, lasers and light emitting diodes. UV-radiation can be supplied using a high intensity continuously emitting system such as those available from Fusion UV Systems. The UV irradiation may also be intermittent or pulsed.

In some embodiments, actinic radiation may be applied to a layer of the viscoelastic adhesive composition such that the composition is partially polymerized or crosslinked. The viscoelastic adhesive composition may be disposed between the display panel and the substantially transparent substrate and then partially polymerized or crosslinked. The viscoelastic adhesive composition may be disposed on the display panel or the substantially transparent substrate and partially polymerized, then the other of the display panel and the substrate may be disposed on the partially polymerized or crosslinked layer.

In some embodiments, actinic radiation may be applied to a layer of the viscoelastic adhesive composition such that the composition is completely or nearly completely polymerized or crosslinked. In one embodiment, the viscoelastic adhesive composition may be disposed between the display panel and the substantially transparent substrate and then completely or nearly completely polymerized or crosslinked. In another embodiment, the viscoelastic adhesive composition may be disposed on the display panel or the substantially transparent substrate and completely or nearly completely polymerized or crosslinked, then the other of the display panel and the substrate may be disposed on the polymerized or crosslinked layer.

In the assembly process, it is generally desirable to have a layer of the viscoelastic adhesive composition that is substantially uniform. Radiation may then be applied to form the viscoelastic adhesive layer.

### Display Panels

In some particular embodiments, the laminate is comprised of a display panel selected from an organic light-emitting diode display, an organic light-emitting transistor display, a liquid crystal display, a plasma display, a surface-conduction electron-emitter display, a field emission display, a quantum dot display, a liquid crystal display, a micro-electromechanical system display, a ferro liquid display, a thick-film dielectric electroluminescent display, a telescopic pixel display, or a laser phosphor display.

The display panel may include any type of panel such as a liquid crystal display panel. Liquid crystal display panels are well known and typically comprise a liquid crystal material disposed between two substantially transparent substrates such as glass or polymer substrates. On the inner surfaces of the substantially transparent substrates are transparent electrically conductive materials that function as electrodes. In some cases, on the outer surfaces of the substantially transparent substrates are polarizing films that pass essentially only one polarization state of light. When a voltage is applied selectively across the electrodes, the liquid crystal material reorients to modify the polarization state of light, such that an image is created. The liquid crystal display panel may also comprise a liquid crystal material disposed between a thin film transistor array panel having a plurality of thin film transistors arranged in a matrix pattern and a common electrode panel having a common electrode.

The display panel may include a plasma display panel. Plasma display panels are well known and typically comprise an inert mixture of noble gases such as neon and xenon disposed in tiny cells located between two glass panels. Control circuitry charges electrodes within the panel which causes the gases to ionize and form a plasma, which then excites phosphors to emit light.

The display panel may include an organic electroluminescence panel. These panels are essentially a layer of an organic material disposed between two glass panels. The organic material may comprise an organic light emitting diode (OLED) or a polymer light emitting diode (PLED). These panels are well known.

The display panel may include an electrophoretic display. Electrophoretic displays are well known and are typically used in display technology referred to as electronic paper or e-paper. Electrophoretic displays comprise a liquid charged material disposed between two transparent electrode panels. Liquid charged material may comprise nanoparticles, dyes and charge agents suspended in a nonpolar hydrocarbon, or microcapsules filled with electrically charged particles suspended in a hydrocarbon material. The microcapsules may also be suspended in a layer of liquid polymer.

The display panel may include an electrowetting display.

The optical assemblies and/or display panels disclosed herein may be used in a variety of optical devices including, but not limited to, a handheld device such as a phone, a television, a computer monitor, a projector, an automotive display, a tablet or a sign. The optical device may comprise a backlight or self-emitting.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

TABLE 1
Materials.

| Trade name or | | |
|---|---|---|
| abbreviation | Description | Source |
| BA | n-Butyl acrylate | BASF Corporation, Florham Park, NJ |
| 2-EHA | 2-Ethylhexyl acrylate | BASF Corporation, Florham Park, NJ |
| HEA | 2-Hydroxyethyl acrylate | Kowa American Corp., New York, |
| | | NY and Sigma-Aldrich Co., St. |
| | | Louis, MO |
| Acm | Acrylamide | Dia-Nitrix Co., Ltd., Tokyo, Japan |
| HPA | Hydroxypropyl acrylate | Dow Chemical Company, Midland, |
| | | MI |
| IEM | Isocyanatoethyl methacrylate | Showa Denko, Kanagawa, Japan |
| IOTG | Iso-octyl thioglycolate | Evans Chemetics LP, Teaneck, NJ |
| tDDM | tert-Dodecyl mercaptan | Arkema Inc, King of Prussia, PA |
| VAZO 67 | 2,2′-azobis(2-methylbutanenitrile | DuPont Company, Wilmington, DE |
| VAZO 64 | 2,2′-azobis(isobutyronitrile | DuPont Company, Wilmington, DE |
| VAZO 52 | 2,2′-azobis(2,4-dimethyl-pentanenitrile) | DuPont Company, Wilmington, DE |
| VAZO 88 | 1,1′-Azobis(cyclohexanecarbonitrile) | DuPont Company, Wilmington, DE |
| LUPERSOL 101 | 2,5-Bis(tert-butylperoxy)-2,5-dimethylhexane | Atofina Chemical Inc., Houston, TX |
| LUPERSOL 130 | 2,5-Di(tert-butylperoxy)-2,5-dimethyl-3-hexyne | Atofina Chemical Inc., Houston, TX |
| Irgacure 184 | 1-Hydroxycyclohexyl phenyl ketone | Sigma-Aldrich Co., St. Louis, MO |
| MEHQ | Hydroquinone monomethyl ether | Sigma-Aldrich Co., St. Louis, MO |
| Irganox 1010 | Pentaerythritol tetrakis(3-(3,5-di-tert-butyl-4- | BASF Corporation, Florham Park, NJ |
| | hydroxyphenyl)propionate) | |
| Desmodur I (IPDI) | Isophorone diisocyanate | Bayer, Pittsburgh, PA |
| Fomrez 55-112 | Poly(neopentyl adipate)diol, 1000 g/mol | Chemtura, Middlebury, CT, USA. |
| CN3100 | Low viscosity acrylic monomer with hydroxyl | Sartomer Americas, Exton, PA, USA |
| | functionality | |
| DBTDL | Dibutyltin dilaurate | Sigma-Aldrich Co., St. Louis, MO |
| BHT | (2,6-bis(t-butyl)-4-methylphenol | Sigma-Aldrich Co., St. Louis, MO |
| MEK | Methyl ethyl ketone | Sigma-Aldrich Co. St. Louis, MO and |
| | | J.T. Baker, Center Valley, PA |
| | n-Propanol | Sigma-Aldrich Co., St. Louis, MO |
| | Ethyl acetate | BDH Chemicals |
| THF | Tetrahydrofuran | Sigma-Aldrich Co., St. Louis, MO |

### Test Methods

### Solids Content Test Method

Duplicate samples were deposited into pre-weighed aluminum pans and subsequently dried at 105° C. for a minimum of 3 hours (or alternatively dried at 160° C. for 45 minutes under vacuum). Polymer solids content was an average of two samples which were gravimetrically analyzed relative to wet weight.

### Determination of Molecular Weight Distribution

The molecular weight distribution of the compounds was characterized using conventional gel permeation chromatography (GPC). The GPC instrumentation, which was obtained from Waters Corporation (Milford, Mass., USA), included a high pressure liquid chromatography pump (Model 1515HPLC), an auto-sampler (Model 717), a UV detector (Model 2487), and a refractive index detector (Model 2410). The chromatograph was equipped with two 5 micron PLgel MIXED-D columns, available from Varian Inc. (Palo Alto, Calif., USA).

Samples of polymeric solutions were prepared by dissolving polymer or dried polymer materials in tetrahydrofuran at a concentration of 0.5 percent (weight/volume) and filtering through a 0.2 micron polytetrafluoroethylene filter that is available from VWR International (West Chester, Pa., USA). The resulting samples were injected into the GPC and eluted at a rate of 1 milliliter per minute through the columns maintained at 35° C. The system was calibrated with polystyrene standards using a linear least squares fit analysis to establish a calibration curve. The weight average molecular weight (Mw) and the polydispersity index (weight average molecular weight divided by number average molecular weight) were calculated for each sample against this standard calibration curve.

### Acrylic Polymer Synthesis

### Example 1

A solution was prepared by stirring 65.12 grams 2-EHA, 20.0 grams BA, 7.0 grams Acm, 7.0 grams n-propanol, 3.0 grams HPA, 0.10 gram IRGANOX 1010 antioxidant, 4.00 grams of 10.0 weight percent tDDM (chain transfer agent) in 2-EHA, and 0.82 gram of 2.44 weight percent MEHQ in 2-EHA within an 8 ounce glass jar and heating to 60° C. The solution was cooled to 45° C. A mixture of 0.48 gram of 0.25 weight percent solids VAZO 52 in 2-EHA was added and mixed. Then 80 grams of the mixture was transferred to a stainless steel reactor (VSP2 adiabatic reaction apparatus equipped with a 316 stainless steel can that can be obtained from Fauske and Associated Inc., Burr Ridge, Ill.). The reactor was purged of oxygen while heating and pressurized with 60 psi of nitrogen gas before reaching the induction temperature of 61° C. The polymerization reaction proceeded under adiabatic conditions to a peak reaction temperature of 130° C., which is reported as Peak Reaction Temperature 1 in Table 3. A 5.0 gram aliquot was taken from the reaction mixture and the unreacted monomer/solvent was 55.95 weight percent based on the total weight of the mixture, which is reported as Percent Volatiles 1 in Table 3.

A solution was prepared by mixing 1.0 gram VAZO 52 initiator, 0.10 gram VAZO 88 initiator, 0.05 gram LUPERSOL 101 peroxide, 0.15 gram LUPERSOL 130 peroxide, and 48.70 grams ethyl acetate in a 4 ounce glass jar. The mixture was shaken on a reciprocating mixer to dissolve the solids. Then, 0.7 gram of the solution and 0.35 gram of 10.0 weight percent tDDM in 2-EHA were stirred into the stainless steel reactor. The reactor was purged of oxygen while heating and then pressurized with 60 pounds per square inch (psi) of nitrogen gas before reaching the induction temperature of 59° C. The polymerization reaction proceeded under adiabatic conditions to a peak reaction temperature of 145° C., which is reported as Peak Reaction Temperature 2 in Table 3. The mixture was isothermally held at that temperature for 60 minutes and then drained into an 8 oz. jar. A sample was taken and the unreacted monomer/solvent was 9.70 weight percent based on the total weight of the mixture, which is reported as Percent Volatiles 2 in Table 3.

### Example 2

A solution was prepared by stirring 54.30 grams 2-EHA, 30.0 grams BA, 7.0 grams Acm, 3.0 grams HPA, 0.10 gram IRGANOX 1010 antioxidant, 5.00 grams of 10.0 weight percent tDDM (chain transfer agent) in 2-EHA, and 0.82 gram of 2.44 weight percent MEHQ in 2-EHA within an 8 ounce glass jar and heating to 60° C. The solution was cooled to 45° C. A mixture of 0.40 gram of 0.25 weight percent solids VAZO 52 in 2-EHA was added and mixed. Then, 80 grams of the mixture was transferred to the stainless steel reactor described in Example 1. The reactor was purged of oxygen while heating and pressurized with 60 psi of nitrogen gas before reaching the induction temperature of 61° C. The polymerization reaction proceeded under adiabatic conditions to a peak reaction temperature of 132° C., which is reported as Peak Reaction Temperature 1 in Table 3. A 5.0 gram aliquot was taken from the reaction mixture and the unreacted monomer/solvent was 55.26 weight percent based on the total weight of the mixture, which is reported as Percent Volatiles 1 in Table 3.

A solution was prepared by mixing 1.0 gram VAZO 52 initiator, 0.10 gram VAZO 88 initiator, 0.05 gram LUPERSOL 101 peroxide, 0.15 gram LUPERSOL 130 peroxide, and 48.70 grams ethyl acetate in a 4 ounce glass jar. The mixture was shaken on a reciprocating mixer to dissolve the solids. Then, 0.7 gram of the solution was stirred into the stainless steel reactor. The reactor was purged of oxygen while heating and then pressurized with 60 pounds per square inch (psi) of nitrogen gas before reaching the induction temperature of 59° C. The polymerization reaction proceeded under adiabatic conditions to a peak reaction temperature of 149° C., which is reported as Peak Reaction Temperature 2 in Table 3. The mixture was isothermally held at that temperature for 60 minutes and then drained into an 8 ounce jar. A sample was taken and the unreacted monomer/solvent was 8.83 weight percent based on the total weight of the mixture, which is reported as Percent Volatiles 2 in Table 3.

### Example 3

Example 3 was synthesized according to the formulation provided in Table 2, using the procedures described in Example 1 and Example 2. The peak reaction temperatures and percent volatiles are provided in Table 3.

### Example 4

Example 4 was synthesized according to the formulation provided in Table 2, using the procedures described in Example 1 and Example 2, with the additional step that IEM was vacuum charged to the reactor and the contents held at about 150° C. under isothermal conditions for about 20 minutes. Then 0.75 pph photoinitiator (IRGACURE-184) was added to the reactor. The reactor was further stirred for 30 minutes and the mixture was drained. The peak reaction temperatures and percent volatiles are provided in Table 3.

TABLE 2
Composition of acrylic formulations.

| | 2-EHA | BA | Acm | HPA | n-Propanol | Vazo 52 | tDDM | IEM | Irgacure 184 |
|---|---|---|---|---|---|---|---|---|---|
| Example | (wt %) | (wt %) | (wt %) | (wt %) | (pph) | (pph) | (pph) | (pph) | (pph) |
| 1 | 70 | 20 | 7 | 3 | 7 | 0.0012 | 0.40 | — | — |
| 2 | 60 | 30 | 7 | 3 | 7 | 0.0010 | 0.50 | — | — |
| 3 | 60 | 30 | 7 | 3 | 7 | 0.0010 | 0.60 | — | — |
| 4 | 60 | 30 | 7 | 3 | 7 | 0.0010 | 0.15 | 0.44 | 0.75 |

TABLE 3
Measured properties of acrylic materials.

| Exam- | Peak Reaction | Peak Reaction | Percent | Percent | M_{w} |
|---|---|---|---|---|---|
| ple | Temperature 1 | Temperature 2 | Volatiles 1 | Volatiles 2 | (kDa) |
| 1 | 130 | 151 | 55.95 | 9.70 | 93 |
| 2 | 132 | 149 | 55.26 | 8.83 | 76 |
| 3 | 138 | 147 | 53.01 | 7.95 | 67 |
| 4 | 131 | 157 | 64.8 | NT | 219 |

### Polyacrylic Viscosity Measurement

The viscosity was measured with a TA Instruments DHR-2 rheometer using 20 mm parallel plates (TA Instruments, New Castle, Del.). The melt viscosity was measured at temperatures from 50° C. to 90° C. (Example 4 was measured at temperatures 50° C. to 130° C.) with shear rates of 0.1 to 100 rad/sec with 3 points per decade and a 10% strain and data was taken at 20° C. temperature intervals. FIG. 3 shows a plot of the complex viscosities of the acrylate polymers of Examples 1 through 4 as a function of shear rate.

### Polyurethane Synthesis

Preparation A. Preparation of 16 equivalents IPDI+14 equivalents Fomrez 55-112 1000 MW poly(neopentyl adipate) diol+2 equivalents HEA

A 2 L 3-necked round-bottomed flask equipped with overhead stirrer was charged with 100 g (0.449843 equivalents) IPDI and 100 g MEK, and heated in a 70° C. oil bath for about 10 min. Then 0.25 g DBTDL (500 ppm based on solids) was added to the reaction. The reaction was placed under a dry air atmosphere and the reaction was fitted with a condenser. Next 500 g (0.393612 equivalents) Fomrez 55-112 diol in 100 g MEK was added to the reaction over 2.5 hours via a pressure equalizing funnel. The funnel was rinsed with 3 times with 20 g MEK each time, and reaction was continued for 48 hours. Then 13.06 g (0.112461 equivalents) hydroxyethyl acrylate and 246.7 g MEK were added to the reaction. After about 24 hours of additional reaction, the reaction was adjusted to 50% solids with the addition of MEK.

Preparation B. Preparation of 70 weight parts [Preparation A]+30 weight parts CN3100.

A 250 mL 3-necked round-bottomed flask equipped with overhead stirrer and distillation head was charged with 59.4 g (29.7 g solids) of Preparation A, 12.72 g CN3100, and 20 mg BHT and heated in a 100° C. oil bath for about 15 minutes under aspirator pressure followed by 15 minutes under mechanical pump pressure of about 20 torr to produce an essentially solvent free 70:30 mixture of the polyurethane and CN3100.

### Polyurethane Viscosity Measurement

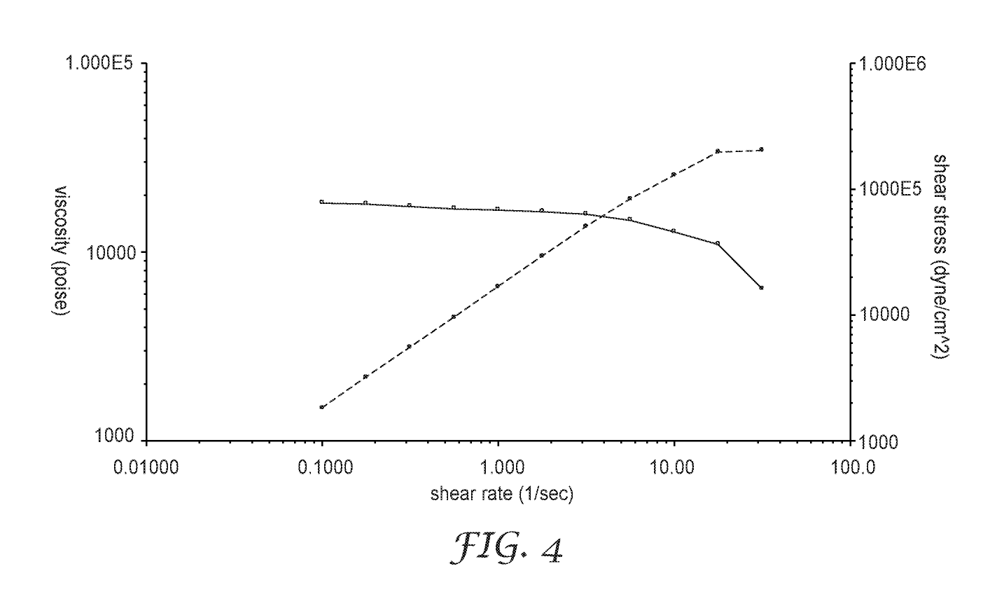

The viscosity was measured with an AR-G2 rheometer using 20 mm parallel plates (TA Instruments, New Castle, Del.). Steady-state shear viscosity was measured with a 1.0 mm gap and a water trap was used to prevent evaporation. The viscosity was measured at temperatures from 10° C. to 90° C. with shear rates of 0.1 to 100 rad/sec and 20° C. temperature intervals. The steady-state shear viscosity was also measured at 25° C. and limited to 20 sec⁻¹ because the melt was spilled between parallel plates at high shear rates. A plot of viscosity versus steady-state shear rate from 0.1 to 100 sec⁻¹ at 25° C. is shown in FIG. 4.

The remaining examples are prophetic.

### Viscosity Measurement Examples

### Extensional Viscosity

A HAAKE™ CaBER™ 1 Capillary Breakup Extensional Rheometer (available from Thermo Fisher Scientific, Inc., Waltham, Mass.) is used to measure the apparent extensional viscosity of optically clear adhesive (OCA) formulations. The apparent extensional viscosity is the ratio of the stress to the stretch rate at the same location. The apparent extensional viscosity is reported in units of Pa·s.

The normalized diameter of OCA samples is measured using the CaBER™ 1 extensional rheometer by placing a small quantity of sample between two circular plates having diameters of 6 mm and using a start height of about 2.0 mm. The top plate is rapidly separated from the bottom plate at a rate of 125 mm/second, thereby forming a filament by imposing an instantaneous level of extensional strain on the fluid sample. The end height is 14.5 mm and the Hencky strain is about 2. The plate velocity profile is linear.

After stretching, the fluid is squeezed together by the capillary force imposing an extensional strain on the fluid. A laser micrometer monitors the midpoint diameter of the thinning fluid filament as a function of time. The normalized diameter is the filament diameter (as a function of time) divided by the initial filament diameter.

The break-up time, i.e. the time at which the normalized diameter is 0, is related to the apparent extensional viscosity. The higher the break-up time, the higher is the apparent extensional viscosity. The relevant extensional parameters of a given fluid, i.e. extensional viscosity and extensional relaxation times can then be quantified.

The Trouton ratio (Tr) is defined as the ratio of extensional viscosity to shear viscosity.

### Shear Viscosity Measurement

Viscosity measurements are made by using an AR2000 Rheometer equipped with a 40 mm, 1° stainless steel cone and plate (available from TA Instruments, New Castle, Delaware). Viscosities are measured at 25° C. using a steady state flow procedure at several shear rates from 0.01 to 100 sec⁻¹ with a 28 micron gap between cone and plate.

### Patch Coater Example

A coating apparatus is constructed as generally depicted in FIG. 1. A substrate support 52 is mounted on precision sliding bearings commercially available as model SHS-15 from THK Co. (Tokyo, JP), and is moved by an actuator commercially available as model ICD10-100A1 linear motor from Kollmorgen (Radford, Va.), provided with a drive/amplifier commercially available as model AKD-P00306-NAEC-0000, also from Kollmorgen. Mounted above the substrate support is a coating head in the form of a slot die having a cavity and being of conventional type, 4 inches (102 mm) wide. The coating head is mounted on a linear actuator commercially available as model ICD 10-100 from Kollmorgen. An encoder integral to the linear actuator is used to monitor the die gap between the slot from the surface of the substrate in cooperation with a physical standard (a precision shim). It is contemplated that other position sensors, such as laser triangulation sensors, can be additionally employed, especially when the flatness of the substrate is an issue. It has been found in practice that the actuator, sensor, physical geometry of the components and the stiffness of the mechanical system all play a role in the ability to achieve both a high dimensional accuracy of the patch and the cleanness of the leading and trailing edges.

A 100 ml stainless steel syringe 90, commercially available as model 702261 from Harvard Precision Instruments, Inc. (Holliston, Mass.), is used to dispense fluid into fluid line 92. The actuator 96 is a model ICD10-100A1 linear motor from Kollmorgen, provided with a drive/amplifier commercially available as model AKD-P00306-NAEC-0000, also from Kollmorgen. The sensor 98 is a read head commercially available as RGH2O L-9517-9125 with a 20 micron tape scale from Renishaw, Inc. (Hoffman Estates, Ill.). The several pressure transducers described above are commercially available as 280E (100 psig range; 689 kPa) from Setra Systems, Inc. (Boxborough, Mass.). Controller 60 is available as CX1030, equipped with a point to point motion profile, from Beckhoff Automation LLC (Burnsville, Minn.).

In the Examples below, motion profiles executed by the controller are used in two manners to achieve precise patch coating. The first manner is to use position profiles to determine the final shape of the patch that is applied. The profiles are initially created by using volumetric calculations and physical models to determine the approximate material flow rate and position at each instant of time. The integral of the flow rate, over the die position relative to the substrates, determines the coated surface's profile. In addition, a profile is entered for positioning the die relative to the surface, as well as the substrate position and velocity relative to the die.

Next, multiple coatings are applied, and the actual achieved profile is measured. Because of higher order physical affects, there are some differences between the predicted edge start position, ending position, and profile and the actual outcome. By iteratively adjusting the motion profile, these differences from the desired profile are attenuated or eliminated. For example, if the patch starting edge is 100 microns late (perhaps because the instant model has some errors from the actual model of the geometry of the pump, die and delivery system, including fluid dynamics), the starting profile may be advanced by a velocity integrated over time to equal to 100 microns. Similarly, if the starting edge is not sharp enough, an initial step can be introduced to provide additional fluid at the start, increasing edge sharpness.

The second manner in which the profiles are used is to manage the position, velocity, acceleration, and jerk rate (or more specifically the position vs. time equation and its first three derivatives). As an example, one might suppose that a good leading or trailing edge can be achieved simply by asking the apparatus to provide as close to an infinitely sharp step as possible. However, experience has shown that several problems occur. One is if the actual profile is not within the controllers capability (due to physical constraints), then differences from the planned path and the actual path occur. This results in coated profile error.

The second aspect is that when high forces are applied to the mechanics, mechanical deflections of the position of the die and pump occur. This causes additional errors. In addition, these defections store energy, which results in a “ringing” of the mechanical components. This can cause applied profile errors long after the initial impulse has occurred. By limiting the derivatives to achievable values, and blending motion segments by keeping the derivatives as continuous as possible across segment boundaries, much higher accuracy is achieved. While motion profiles per se are known in precision motion control, the use of higher derivations is not presently done in connection with precision coating. In addition, no motion profile segments are known in the context of compensating for an undesired coated surface profile.

Further exemplary embodiments of the present disclosure also coordinate the motion of the substrate relative to the die to further enhance the accuracy of the coated patch. For example, suppose it is desirable to approximate an infinitely sharp start of the application of the coating liquid to the substrate (e.g. the thickness of the patch goes from a thickness of 0 microns to a thickness of 300 microns over a relative movement of the die slot and the substrate of zero microns). However, we can dramatically improve upon the positional accuracy by coordinating the profile of the die, pump, and substrate.

Thus, instead of high acceleration motions, we can slowly ramp up all three profiles, so the initial contact of the coating bead to the substrate is at a very slow velocity (near or potentially zero). Then we can ramp up the substrate position in lock step with the pump to deliver an extremely sharp edge. Note also that since high accelerations are not introduced into the system, the profile may be positioned on the substrate with high accuracy.

### Alternative Example

An alternate apparatus is also built, generally similar to the apparatus depicted in FIG. 1, and discussed above, except that the support for the substrate is cylindrical and is put into rotary motion in order to create relative motion between the coating head and the substrate. More specifically, the support is an aluminum drum, 32.4 cm in diameter, whose rotational motion is controlled by a motor, commercially available as model FH5732 from Kollmorgen, coupled to the drum by air bearings commercially available as BLOCK-HEAD 10R from Professional Instruments of Hopkins, Minn.

The drum is cleaned with isopropyl alcohol and allowed to dry. Several sheets of 0.1 mm thick by 300 mm long by 150 mm wide flexible glass commercially available as OA10G from Nippon Electric Glass America, Inc. of Schaumburg, Ill. are adhered to the drum. An adhesive of the present invention is prepared. This adhesive is tested for viscosity according to the shear viscosity test method above.

The adhesive is fed into the empty syringe from the remote reservoir using a pressure of 80 psi (552 kPa). During filling, a vent at the top of the plunger body is open, enabling trapped air to escape. This vent is closed once bubble-free resin is flowing from it. The filling continues until bubble-free resin is flowing from the die slot, then a valve between the coating system (syringe and die) and the remote reservoir is closed. The gap between the die slot and the aluminum drum is verified and the die slot is positioned at its starting gap using a precision shim. The syringe pump feeds into a coating head in the form of a slot die having a 4 inch (10.2 cm) wide by 0.020 inch (0.51 mm) high slot with a 0.001 inch (0.025 mm) overbite.

The controller is programmed to simultaneously control the various actuators in terms of several distinct time segments of not necessarily equal length. These parameters may include time segment (arbitrary units), duration of the segment (sec), cumulative time at end of segment (sec), translation speed of substrate (rotations per minute), distance from slot to substrate (mm), velocity of movement of the slot die to the specified distance (mm per second), and velocity of movement of the syringe plunger (mm per second). Of course, the ordinary artisan will perceive that the programming could be performed in terms of any of several other convenient parameters, such as the distance of longitudinal travel of the substrate.

Eight patches are coated, two per glass sheet, around the circumference of the aluminum drum with small gaps in-between each patch and the next. A position and thickness sensor, commercially available as model LT-9010 M, from Keyence America of Itasca, Ill. is scanned across the coated patches to verify thickness uniformity.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this present disclosure is not to be unduly limited to the illustrative embodiments set forth hereinabove. Furthermore, all publications, published patent applications and issued patents referenced in the Detailed Description are incorporated herein by reference in their entirety to the same extent as if each individual publication or patent was specifically and individually indicated to be incorporated by reference. Various exemplary embodiments have been described. These and other embodiments are within the scope of the following claims.

1. A viscoelastic adhesive composition for use in piece part coating, wherein at a dispensing temperature of between about 35° C. and about 120° C., the viscoelastic adhesive composition can be discretely dispensed and has a tan delta of at least about 1 as determined by dynamic mechanical analysis at a frequency of 1 Hz and a complex viscosity of less than about 5×10³ Pascal-sec at a frequency of about 10 radians·s^{-1.}

2. The viscoelastic adhesive composition of claim 1, wherein the viscoelastic adhesive composition has a Trouton ratio of between about 3 and about 100 at a dispensing temperature of between about 35° C. and about 120° C.

3. The viscoelastic adhesive composition of claim 2, wherein the viscoelastic adhesive composition has a Trouton ratio of between about 3 and about 50 at a dispensing temperature of between about 35° C. and about 120° C.

4. The viscoelastic adhesive composition of claim 3, wherein the viscoelastic adhesive composition has a Trouton ratio of between about 3 and about 25 a dispensing temperature of between about 35° C. and about 120° C.

5. The viscoelastic adhesive composition of claim 1, wherein the viscoelastic adhesive composition has a complex viscosity of less than about 10³ Pa·sec at a frequency of about 10 radians·s⁻¹.

6. The viscoelastic adhesive composition of claim 1, wherein the viscoelastic adhesive composition has a complex viscosity of between about 500 and about 10³ Pascal-sec at a frequency of about 10 radians·s⁻¹.

7. The viscoelastic adhesive composition of claim 1, wherein the composition is one of a (meth)acrylate polymer, polyurethane, silicone, polyester and polyolefin.

8. The viscoelastic adhesive composition of claim 1, wherein the viscoelastic adhesive composition forms an optically clear adhesive.

9. The viscoelastic adhesive composition of claim 1, wherein the viscoelastic adhesive composition forms an optically clear adhesive which remains viscoelastic after coating on the substrate and optional curing.

10. A process comprising:
providing a heated coating head, the heated coating head comprising an external opening in flow communication with a source of a viscoelastic adhesive composition, wherein at a dispensing temperature of between about 35° C. and about 120° C., the viscoelastic adhesive composition has a tan delta of at least about 1 as determined by dynamic mechanical analysis at a frequency of 1 Hz and a complex viscosity of less than about 5×10³ Pascal-sec at a frequency of about 10 radians·s⁻¹;
positioning the heated coating head relative to a first substrate to define a gap between the external opening and the first substrate;
creating relative motion between the heated coating head and the first substrate in a coating direction; and
dispensing a pre-determined quantity of the viscoelastic adhesive composition from the external opening onto at least a portion of at least one major surface of the first substrate to form a discrete patch of the viscoelastic adhesive composition in a predetermined position on at least a portion of the major surface of the first substrate, the patch having a thickness and a perimeter.

11. The process of claim 10, wherein the viscoelastic adhesive composition has a Trouton ratio of between about 3 and about 100 at a dispensing temperature of between about 35° C. and about 120° C.

12. The process of claim 10, wherein the viscoelastic adhesive composition has a Trouton ratio of between about 3 and about 50 at a dispensing temperature of between about 35° C. and about 120° C.

13. The process of claim 10, wherein the viscoelastic adhesive composition has a Trouton ratio of between about 3 and about 25 at a dispensing temperature of between about 35° C. and about 120° C.

14. The process of claim 10, wherein the viscoelastic adhesive composition has a complex viscosity of less than about 10³ Pa·sec at a frequency of about 10 radians·s⁻¹.

15. (canceled)

16. The process of claim 10, wherein the viscoelastic adhesive composition is one of a (meth)acrylate polymer, polyurethane, silicone, polyester and polyolefin.

17. The process of claim 10, wherein the viscoelastic adhesive composition forms an optically clear adhesive composition.

18. The process of claim 10, further comprising curing the patch.

19. The process of claim 18, wherein curing the patch comprises applying heat, actinic radiation, ionizing radiation, or a combination thereof.

20. The process of claim 10, further comprising disposing at least a portion of at least one major surface of a second substrate relative to the first substrate such that the patch is positioned between the first and second substrates.

21. An article comprising:
a first substrate;
a second substrate; and
a viscoelastic adhesive composition positioned between the first substrate and the second substrate, wherein at a dispensing temperature of between about 35° C. and about 120° C., the viscoelastic adhesive composition has a tan delta of at least about 1 as determined by dynamic mechanical analysis at a frequency of 1 Hz and a complex viscosity of less than about 5×10³ Pascal-sec at a frequency of about 10 radians·s⁻¹.
